(19) United States
(12) Patent Application Publication
(10) Pub. No.: US 2010/0119389 A1
(43) Pub. Date: May 13, 2010

(54) MODULAR, BRUSHLESS MOTORS AND APPLICATIONS THEREOF

(76) Inventors: Robert Lazebnik, Clark Lake, MI (US); Patrick J. McCleer, Jackson, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/266,908

(22) Filed: Nov. 7, 2008

(51) Int. Cl. F04D 25/06; H02K 21/12

(52) U.S. Cl. 417/423.7; 310/156.01

(57) ABSTRACT

A modular brushless motor may be reconfigured for different applications and power levels. As one example, a modular fan enables the drive motor, the number of blades, or both, to be factory adjusted to accommodate different power and air-flow requirements. A brushless ring motor comprises a circular ferromagnetic ring having an inner surface and an outer surface rotatable about a central axis, with a plurality of spaced-apart permanent magnets being bonded to one of the inner surface and outer surfaces of the ring. A stator assembly enables one or more coils to be mounted relative to the permanent magnets enabling a commercially available electronic speed controller to the drive the coils in cooperation with the magnets so as to turn the ring. The stator assembly enables different groups of coils to be mounted relative to the permanent magnets, and the ring is configured to accept different numbers of fan blades. This allows the coils and blades to be mixed and matched to target various performance requirements.

### FIELD OF THE INVENTION

This invention relates generally to brushless motors and, in particular, to modular configurations that may be used in air circulators and other applications.

### BACKGROUND OF THE INVENTION

There are three main types of fans used for moving air: axial, centrifugal (also called radial) and cross flow (also called tangential). Axial fans have blades that force air to move parallel to the shaft about which the blades rotate. This type of fan is used in a wide variety of applications, ranging from small cooling fans to giant fans used in wind tunnels.

Most residential and industrial axial fans use a motor having a shaft to which the blades are connected. This has been convenient in terms of manufacture, since component parts, including motors, could come from different sources to optimize a design.

In the past, the cost to ship component fan parts and the cost of energy required for fan operation were largely inconsequential. Today, however, with rising energy prices, the economics associated with the construction and operation of mechanical devices including fans has become a more important factor.

One approach to weight reduction and the cost of operation involves the use of a ring motor. Such drive mechanism, having distributed rotor magnets and stator windings, eliminates the need for a bulky central shaft. Among other advantages, a low-profile cooling system can be constructed.

U.S. Pat. No. 6,600,249, entitled BRUSHLESS DC RING MOTOR COOLING SYSTEM, is directed to a cooling system for a vehicle. A shroud is attachable to a fixed portion of the vehicle, and a stator assembly for a brushless DC ring motor is attached to at least one mounting support of the shroud. A cooling fan is piloted on the stator assembly, and includes a ring supporting a plurality of fan blades for sweeping an area inside the shroud. A rotor assembly for the brushless DC ring motor is attached to the ring of the cooling fan. The stator assembly of the motor includes a plurality of laminations exposed around the outer diameter thereof.

The rotor assembly of the '249 Patent includes a back-iron ring and a plurality of permanent magnets on an inner diameter of the back-iron ring confronting the plurality of laminations exposed around the outer diameter of the stator assembly. The cooling system is controlled by an electronic controller to rotate the cooling fan to provide appropriate cooling for the vehicle. The electronic controller includes a control/communications system operatively connected to an engine control module (ECM) of the vehicle. A DC-to-DC converter is operatively connected to a power source. A commutation switching segment is operatively connected to the DC-to-DC converted and to the control/communications system, and is operable to provide signals for operating the brushless DC ring motor to rotate the cooling fan.

Ring motors are also used for propulsion drive. U.S. Pat. No. 6,606,578 discloses an electromagnetic propulsion fan that includes a hub and a plurality of fan blades coupled to the hub and a rim coupled to the fan blades such that rotating the rim causes the fan blades to rotate. The rim includes a plurality of magnets coupled thereto. A plurality of electromagnets in proximity to the rim are controllable to generate magnetic fields that interact with the magnetic fields of the magnets to cause the rim to rotate.

In terms of residential/commercial applications, U.S. Pat. No. 6,194,798 describes a DC driven fan with blades made of magnetized material. The blades are permanently magnetized in the radial direction and cooperate with a plurality of electromagnetic stator coils mounted external to the outer fan edges. Adjacent blades have alternate N—S, S—N radial magnetic orientations. In one embodiment, the blades are mounted in a non-ferrous hub and in an alternate embodiment they are mounted in a ferrous hub so that adjacent blades function like a U or V-shaped magnet. Blades can be made of magnetized ferrous, ferromagnetic, or magnetized plastic depending upon the application and blade strength specifications.

Despite these applications of distributed/rim-type drive mechanisms, the need remains for a high-efficiency, low-cost fan with modular components driven by a ring motor.

### SUMMARY OF THE INVENTION

This invention relates generally to brushless motors and, in particular, to modular configurations that may be used in air circulators and other applications. In fan applications, such modularity enables the drive motor, the number of blades, or both, to be factory adjusted to accommodate different power and air-flow requirements. The invention is not limited in terms of application, and may be configured for relatively small residential fans to large commercial and industrial units, including belt-driven units.

All embodiments are driven with a brushless ring motor comprising a circular ferromagnetic ring having an inner surface and an outer surface rotatable about a central axis, with a plurality of spaced-apart permanent magnets being bonded to one of the inner surface and outer surfaces of the ring. A stator assembly enables one or more coils to be mounted relative to the permanent magnets enabling a commercially available electronic speed controller to the drive the coils in cooperation with the magnets so as to turn the ring.

In contrast to existing designs, the stator assembly enables different groups of coils to be mounted relative to the permanent magnets to accommodate different power requirements. For example, two, three or more equally spaced groups of coils may be mounted relative to the same ring. In addition, the invention allows different numbers of fan blades to be mounted on or against the ring to accommodate different air-flow requirements. For example, the ring may be configured to accept 3, 6 or 9 fan blades.

According to the invention, the same basic design allows the number of coils, the number of blades, or both, to be varied desired performance requirements. This can be accomplished with the same basic enclosure using the same ring having a fixed number of magnets. This allows, for example, two opposing sets of coils to be used with 3 fan blades, 3 opposing sets of coils to be used with 6 or 9 fan blades, and any other such combinations in accordance with the requirements of a particular application.

### BRIEF DESCRIPTION OF THE DRAWINGS

FIG. 1 is a simplified, front-view drawing of a modular, brushless motor according to the invention;

FIG. 2 is a drawing that shows an embodiment of the invention utilizing three sets of drive coils;

FIG. 3 is a drawing that shows an embodiment of the invention wherein three fan blades are mounted on the outer surface of a rotor ring;

FIG. 4 is a drawing that shows six fan blades mounted on the outer surface of a rotor ring; and

FIG. 5 is a drawing that shows nine fan blades mounted on the outer surface of a rotor ring.

### DETAILED DESCRIPTION OF THE INVENTION

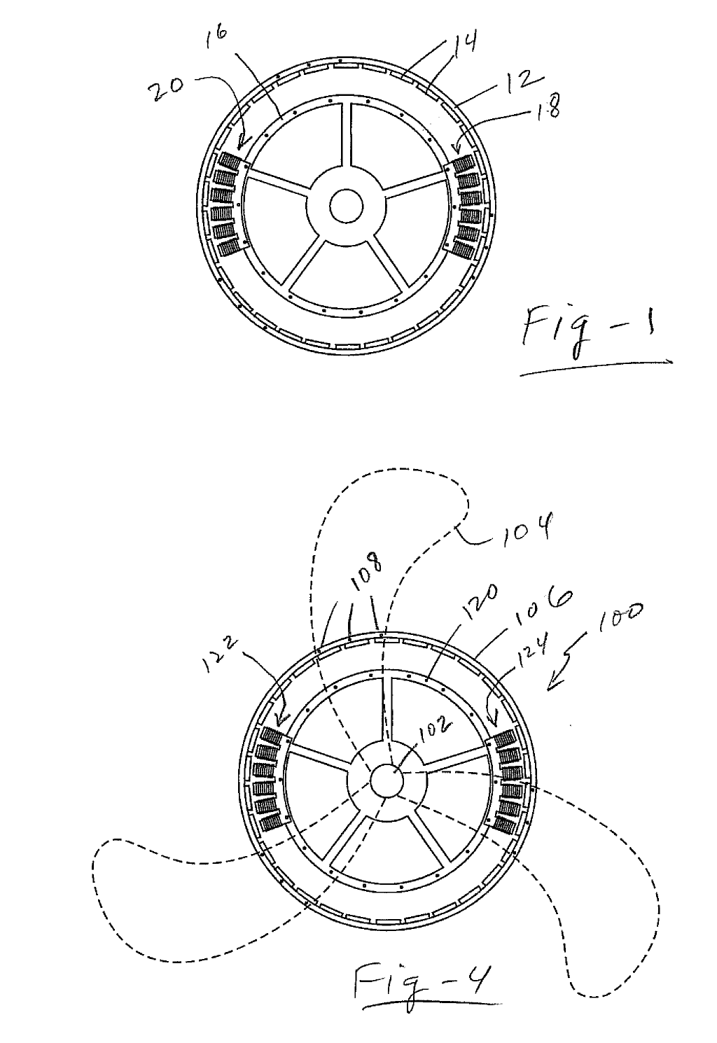

FIG. 1 is a simplified, front-view drawing of a modular, brushless motor according to the invention. A rotor ring 12 is comprised of a ferromagnetic “back iron” material having inner and outer cylindrical surfaces. The ring 12 is provided with radially oriented permanent magnets 14 on the inner (or outer) surface, magnetized in a circumferentially symmetric, alternating, multi-pole arrangement.

The stator of the motor includes a number of discrete, individual stator segments, each comprised of electric coils wound on an arrangement of ferromagnetic teeth connected together by a common ferromagnetic flux return yoke structure. The coils are oriented toward and are magnetically coupled to the individual pole magnets of the rotor ring through air gaps established through physical spacing. The windings of the stator segments are connected in a series or parallel arrangement and brought out to a common location where they connect to an electronic speed controller.

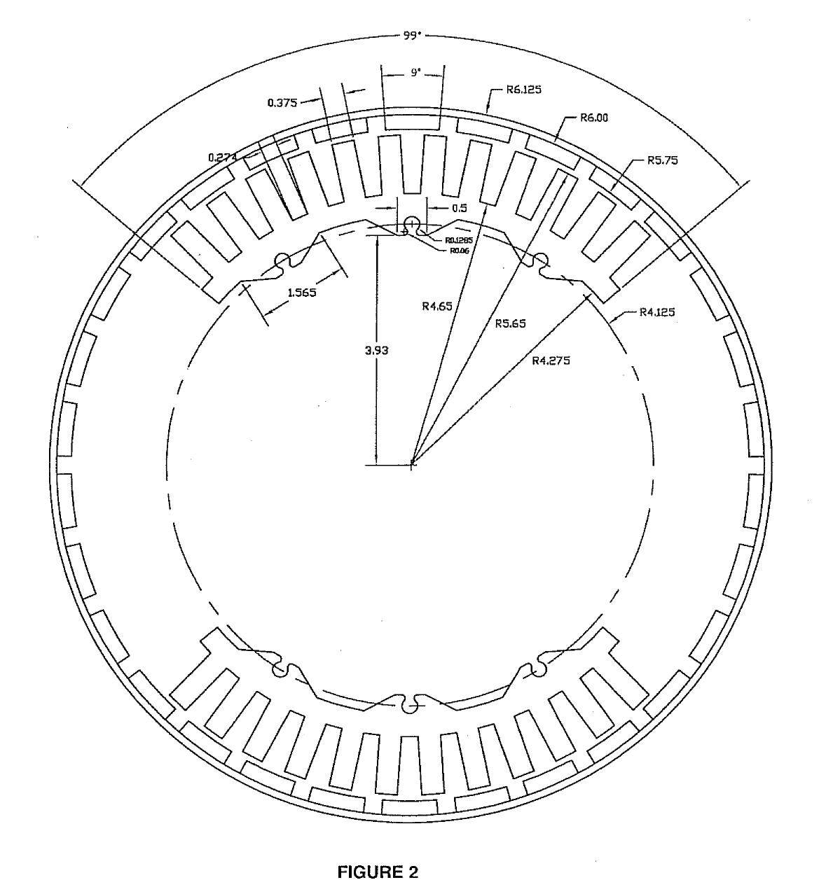

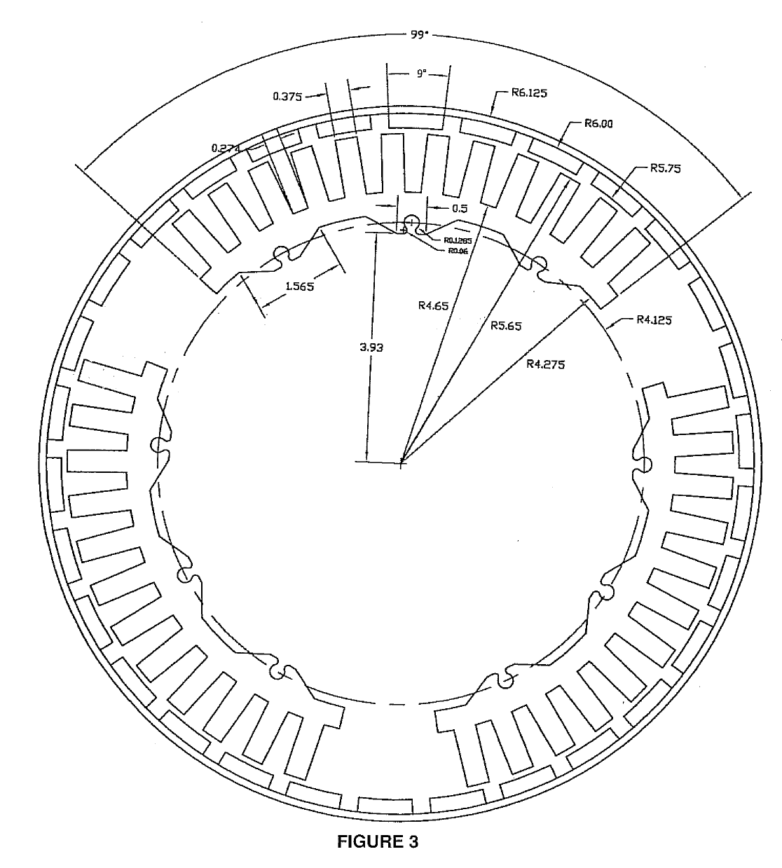

Continuing the reference to FIG. 1, in contrast to existing designs, the stator includes a ring 16 or other mounting structure onto which sets of drive coils 14, 16 may be mounted in modular configurations as desired to address different application requirements. For example, FIG. 2 shows a stator assembly with two segments and FIG. 3 shows a stator assembly with three segments. The three segment stator machine will be 50% more powerful than the two segment stator machine. The stators are on the inside of the rotor ring which has thirty magnets, to make a thirty pole machine, though the invention is not limited in that more or fewer permanent magnets may be used and they may be mounted to the outer surface of the ring. Any type of magnets may be used, including rare-earth types or lower-cost ceramic magnets. While the stator teeth in FIGS. 2 and 3 are shown without windings, when finished each tooth will be wound with a single coil of wire. The invention is not limited in terms of the specific dimensions shown in the diagrams.

The number of individual stator segments can vary from one up to almost any arbitrary number, but most commonly would be limited to a low number (two, three, or four) of identically constructed segments, symmetrically placed around the interior surface of the ring (or exterior surface of the rotor ring structure if the magnets are mounted on the outer surface). The use of multiple, equally spaced coil banks are preferred for balancing to minimize long term deformation due to vibrational effects.

Among other applications, this basic modular brushless design may be used to replace the torque transmission element in a typical propeller fan drive—i.e., a central shaft connecting a drive motor to a propeller hub. In such applications, the ring, comprising the rotor of the motor, is rigidly mounted to a fan propeller structure at a radial position between the central hub and the propeller blade outer tips. Alternatively, the rotor ring may be used for belt-driven applications, as shown in FIG. 8.

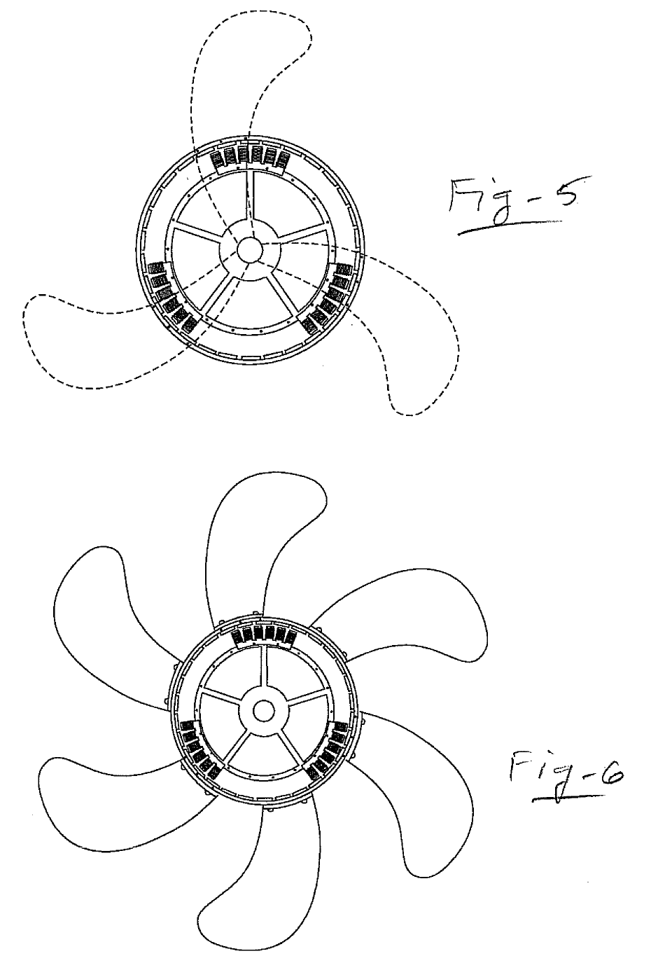

FIG. 4 is a simplified, front-view drawing of a fan embodiment of the invention, depicted generally at 100. Blades 104 are attached to a rotatable hub 102. The blades 104 are attached to the rotor ring 106 via fasteners 108. The stator includes a 120 or other support structure to which two sets stator coils 122, 124 are attached. As the rotor ring 106 has thirty magnets, this again represents a thirty-pole machine.

According to a particular configuration to be powered by a transistor three-phase drive fed by rectified 120 VAC, each coil is wound with a single coil of sixty turns. The axial stack length of the stator and rotor is approximately ⅜ of an inch. The rotor ring 106 has an ID of 12 inches and is ⅛ inch thick. The magnets are ¼ inch thick, and the air gap length between the magnet if) and the stator tooth OD is 1/10 inch. The stator radial thickness is 1⅜ inches, with 1.0 inch of that being slot depth and ⅜ inch being the stator back-iron thickness. Calculations indicate that with two 12-tooth/8-pole motor segments having an axial stack length of ⅜ inch, which would cover approx 16/30 of the rotor inner surface, approximately ½ horsepower of drive should be realized at a rotational speed of 1800 rpm.

Since, in the preferred embodiments, the motor drive uses three-phase AC, there are three stator teeth/slots for every pole pair, as shown in the drawings. Using such a configuration ensures that the fan will always start up from a stop. Since the currents in adjacent coils are 120 degrees out of phase, this creates a traveling wave through the air gap which will ultimately synchronize with the permanent magnets and cause the blades to rotate.

However, because the controller commands rotor rotation, the controller needs some way of determining the rotor's rotational orientation relative to the stator coils. While Hall-effect sensors or a rotary encoder may be used to directly measure the rotor's position, in the preferred embodiments the back EMF in the undriven coils is used to infer the rotor position. This eliminates the need for separate sensors, facilitating sensorless control. However, since no back-EMF is produced when the rotor is stationary, the magnetic field rotates at a certain frequency during start-up.

The frequency is slowly increased to keep the rotor in step with the rotating magnetic field. Once a certain speed about 5% or 10% of the rated speed is achieved, the drive switches over to self-synchronous control or true sensorless control. That is, as the initial frequency is slowly increased, the movement of the traveling wave increases as well until it levels off at a given speed that the user has set. Once the synchronous mode of operation is achieved the controller knows exactly where the rotor is.

The invention is not limited in terms of the controller electronics in that a proprietary or off-the shelf chip set may be used. Since the windings of the stator coils are preferably connected in a three-phase electrical configuration, the fan can then be driven and controlled by commercially available sensor-less, three-phase, permanent-magnet-motor solid-state drives. For example, the IRMCF341 controller chip from International Rectifier of El Segundo, Calif. (which has a number of closely related variants) provides a current-regulated sensorless control algorithm with an integrated speed controller. The system determines what the current should be such that when synchronism is established current is automatically regulated for a given amount of torque. At this point the system can actually measure and regulate speed in accordance with user control.

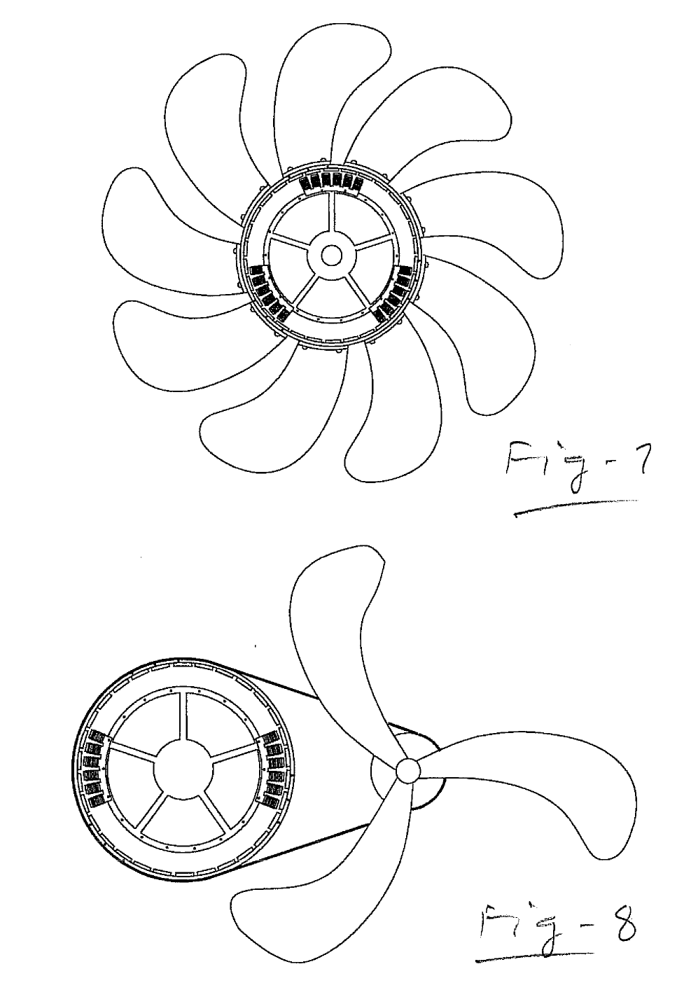

According to the invention, a common “base” structure comprised of a rotor ring, as described above, attached radially to a common hub, allows a varying number of propeller blades to be rigidly attached to provide for a varying level of air flow at a given rotational speed. FIG. 5, for example, shows an embodiment of the invention utilizing three sets of drive coils symmetrically placed around the interior surface of the rotor ring and three fan blades mounted to the rotor ring. The blades may also be mounted on the outer surface of the ring. FIG. 6, for example, shows six fan blades mounted on the outer surface of a rotor ring, and FIG. 7 shows nine fan blades mounted on the outer surface of a rotor ring.

By varying the number of stator segments, as described above, one can adjust the needed rotational drive power for different blade arrangements in a modular manner. As such, a number of fan powers (or a number of commercial products) can be provided by use of a single base structure (housing and rotor ring), with the addition or subtraction of blade and stator elements, all of a common design. In addition, as shown in FIG. 8, the rotor ring may be used for belt-driven applications to drive fan blades or other rotating machinery.

We claim:

1. A modular fan, comprising:
a circular ferromagnetic ring having an inner surface and an outer surface rotatable about a central axis;
a plurality of spaced-apart permanent magnets bonded to one of the inner surface and outer surfaces of the ring;
a stator assembly enabling different groups of coils to be mounted relative to the permanent magnets;
a plurality of fan blades mounted to the rotatable ring; and an electronic speed controller operative to the drive the coils to form a brushless motor in cooperation with the magnets, thereby turning the fan blades.

2. The modular fan of claim 1, wherein the stator assembly enables two, three or more equally spaced groups of coils to be mounted relative to a fixed number of magnets to accommodate different fan power requirements.

3. The modular fan of claim 1, wherein the ring is configured to allow different numbers of fan blades to be mounted thereon to accommodate different air-flow requirements.

4. A modular fan, comprising:
a circular ferromagnetic ring having an inner surface and an outer surface rotatable about a central axis;
a plurality of spaced-apart permanent magnets bonded to one of the inner surface and outer surfaces of the ring;
a stator assembly including a plurality of coils mounted relative to the permanent magnets;
the ring being configured to allow different numbers of fan blades to be mounted thereon to accommodate different air-flow requirements; and
an electronic speed controller operative to the drive the coils to form a brushless motor in cooperation with the magnets, thereby turning the fan blades.

5. The modular fan of claim 4, wherein the stator assembly enables different groups of coils to be mounted relative to the permanent magnets.

6. The modular fan of claim 5, wherein the stator assembly enables two, three or more equally spaced groups of coils to be mounted relative to a fixed number of magnets to accommodate different fan power requirements.

7. A modular fan, comprising:
a circular ferromagnetic ring having an inner surface and an outer surface rotatable about a central axis;
a plurality of spaced-apart permanent magnets bonded to one of the inner surface and outer surfaces of the ring;
a stator assembly enabling different groups of coils to be mounted relative to the permanent magnets;
the ring being configured to allow different numbers of fan blades to be mounted thereon;
an electronic speed controller operative to the drive the coils to form a brushless motor in cooperation with the magnets, thereby turning the fan blades; and
wherein the number of coils and the number of fan blades may be varied to accommodate differing air-flow requirements.
